(19) United States
(12) Patent Application Publication
(10) Pub. No.: US 2009/0135190 A1
(43) Pub. Date: May 28, 2009

(54) Multimode parallel graphics rendering systems and methods supporting task-object division

(75) Inventors: Reuven Bakalash, Shdema (IL); Yaniv Leviathan, Savyon (IL); Nadav Sherman, Ra'anana (IL)

Correspondence Address: Thomas J. Perkowski , Esq., P. C., Soundview Plaza, 1266 East Main Street, Stamford, CT, 06902, US

(73) Assignee: Lucid Information Technology, Ltd.

(21) Appl. No.: 12/229,215

(22) Filed: Aug. 20, 2008

Related U.S. Application Data
(63) Continuation-in-part of application No. 12/077,072, filed on Mar. 14, 2008.
Application No. 12/077,072 is a continuation-in-part of application No. 11/897,536, filed on Aug. 30, 2007.
Application No. 11/897,536 is a continuation-in-part of application No. 11/789,039, filed on Apr. 23, 2007, now abandoned.
Application No. 11/789,039 is a continuation-in-part of application No. 11/655,735, filed on Jan. 18, 2007.
Application No. 11/655,735 is a continuation-in-part of application No. 11/648,160, filed on Dec. 31, 2006.
Application No. 11/648,160 is a continuation-in-part of application No. 11/386,454, filed on Mar. 22, 2006.
Application No. 11/386,454 is a continuation-in-part of application No. 11/340,402, filed on Jan. 25, 2006.
Application No. 11/340,402 is a continuation-in-part of application No. 10/579,682, filed on Mar. 23, 2007.
(60) Provisional application No. 60/759,608, filed on Jan. 18, 2006.
(60) Provisional application No. 60/647,146, filed on Jan. 25, 2005.
(60) Provisional application No. 60/523,084, filed on Nov. 19, 2003.

(51) Int. Cl. G06T 1/20

(52) U.S. Cl. 345/506

(57) ABSTRACT

In a PC-level hosting computing system embodying a parallel graphics processing subsystem (PGPS) having a plurality of GPPLs and supporting at least a task-based object division mode of parallel operation, a method of method of operating the GPPLs its task-based object division mode of operation during the run-time of a graphics based application executing on the CPU(s) of the host computing system, and, within each frame in the scene to be rendered, analyzing the stream of graphics commands and data generated by the graphics application for graphics processing tasks associated the frame. The graphics processing tasks are then distributed among plurality of GPPLs, and each GPPL executes its received graphics processing tasks, by processing the graphics commands and data associated with its distributed graphics processing tasks, and renders partial image components. The partial image components are ultimately recomposited to produce a complete image for the frame and the complete image is displayed on one or more display screens. In a preferred embodiment, the partial image components are rendered in the GPPLs using a depth-less based method of image rendering.

### CROSS-REFERENCE TO RELATED CASES

The present application is a Continuation-in-Part (CIP) of the following Applications: Ser. No. 12/077,072 filed Mar. 14, 2008; Ser. No. 11/897,536 filed Aug. 30, 2007; U.S. application Ser. No. 11/789,039 filed Apr. 23, 2007; U.S. application Ser. No. 11/789,039 filed Apr. 23, 2007; U.S. application Ser. No. 11/655,735 filed Jan. 18, 2007, which is based on Provisional Application Ser. No. 60/759,608 filed Jan. 18, 2006; U.S. application Ser. No. 11/648,160 filed Dec. 31, 2006; U.S. application Ser. No. 11/386,454 filed Mar. 22, 2006; U.S. application Ser. No. 11/340,402 filed Jan. 25, 2006, which is based on Provisional Application No. 60/647,146 filed Jan. 25, 2005; U.S. application Ser. No. 10/579,682 filed May 17, 2006, which is a National Stage Entry of International Application No. PCT/IL2004/001069 filed Nov. 19, 2004, which is based on Provisional Application Ser. No. 60/523,084 filed Nov. 19, 2003; each said patent application being commonly owned by Lucid Information Technology, Ltd., and being incorporated herein by reference as if set forth fully herein.

### BACKGROUND OF INVENTION

1. Field of Invention

The present invention relates generally to the field of 3D computer graphics rendering, and more particularly, to ways of and means for improving the performance of parallel graphics rendering processes running on 3D parallel graphics rendering systems supporting the decomposition of 3D scene objects among its multiple graphics processing pipelines (GPPLs).

2. Brief Description of the State of Knowledge in the Art

Applicants' copending U.S. patent application Ser. No. 11/897,536, incorporated herein by reference, in its entirety, discloses diverse kinds of PC-level computing systems embodying different types of parallel graphics rendering subsystems (PGRSs) with graphics processing pipelines (GPPLs) generally illustrated in FIG. 1. The multi-pipeline architecture of such systems can be realized using GPU-based GPPLs, as shown in FIG. 2A. Alternatively, the multi-pipeline architecture of such systems can be realized using multi-core CPU based GPPLs (e.g. Larrabee by Intel Corp.) as shown in FIG. 2B.

In general, such graphics-based computing systems support multiple modes of graphics rendering parallelism across their GPPLs, including image and object division modes, which can be adaptively and dynamically switched into operation during the run-time of any graphics application running on the host computing system. While each mode of parallel operation has its advantages, as described in copending U.S. patent application Ser. No. 11/897,536, supra, the object division mode of parallel operation is particularly helpful during the running of interactive gaming applications because this mode has the potential of resolving many bottleneck conflicts which naturally accompany such demanding applications.

Today, real-time graphics applications, such as advanced video games, are more demanding than ever, utilizing massive textures, abundance of polygons, high depth-complexity, anti-aliasing, multi-pass rendering, etc., with such robustness growing exponentially over time.

Clearly, conventional PC-based graphics systems fail to address the dynamically changing needs of modern graphics applications. By their very nature, prior art PC-based graphics systems are unable to resolve the variety of bottlenecks (e.g. geometry limited, pixel limited, data transfer limited, and memory limited) summarized in FIG. 3C1 of copending U.S. patent application Ser. No. 11/897,536, that dynamically arise along 3D graphic pipelines. Consequently, such prior art graphics systems are often unable to maintain a high and steady level of performance throughout a particular graphics application.

Thus, a given pipeline along a parallel graphics system is only as strong as the weakest link of it stages, and thus a single bottleneck determines the overall throughput along the graphics pipelines, resulting in unstable frame-rate, poor scalability, and poor performance.

And while each parallelization mode described above and summarized in copending U.S. patent application Ser. No. 11/897,536, solves only part of the bottleneck dilemma currently existing along the PC-based graphics pipelines, no one parallelization method, in and of itself, is sufficient to resolve all bottlenecks in demanding graphics applications, and enable quantum leaps in graphics performance necessary for photo-realistic imagery in real-time interactive graphics environments.

Thus, there is a great need in the art for a new and improved way of and means for practicing parallel 3D graphics rendering processes in modern multiple-GPU based computer graphics systems, while avoiding the shortcomings and drawbacks of such prior art methodologies and apparatus.

### OBJECTS AND SUMMARY OF THE PRESENT INVENTION

Accordingly, a primary object of the present invention is to provide a new and improved method of and apparatus for practicing parallel 3D graphics processes in modern multiple-GPU based computer graphics systems, based on monitoring the graphics workloads in a sub-frame resolution, treating graphics tasks as objects, and parallelize graphics task-objects in 3D scenes, among multiple graphics processing pipelines (GPPLs).

Another object of the present invention is to a new and improved parallel graphics processing subsystem that matches the optimal parallel mode of division to the graphics workload, at each instant of time during the running a graphics-based application.

Another object of the present invention is to provide such a parallel graphics processing subsystem supporting various division modes among GPPLs; image division, object division, and improved object division with no recomposition.

Another object of the present invention is to provide a new and improved method of parallel graphics processing on a parallel graphics processing system that is capable of real-time modification of the flow structure of the incoming graphics commands such that multi-mode parallelism is carried out among GPPLs in an optimal manner.

Another object of the present invention is to a provide new and improved parallel graphics processing system that carries out real-time (i.e. online) decisions on what is the best parallelization method to operate the GPPLs, and to modify the flow of the incoming commands in real-time accordingly.

Another object of the present invention is to a new and improved method of controlling the operation of parallel graphics processing among a plurality of GPPLs on a parallel graphics processing system according to a new type of object-division parallelism, involving the performance of sub-frame division, wherein each frame of a 3D scene to be rendered is divided into a set of minimal tasks (where each task is considered as a macro-object of sorts), and then, in the spirit of object-division parallelism, the processing of these divided tasks are distributed between multiple GPU's.

Another object of the present invention is to a new and improved parallel graphics processing system having object-division mode of parallel graphics processing, wherein each frame of a 3D scene to be rendered is divided into a set of minimal tasks (where each task is considered as a macro-object of sorts), and then, in the spirit of object-division parallelism, the processing of these divided tasks are distributed between multiple GPU's in a real-time manner during the run-time of the graphics-based application executing on the CPU(s) of associated host computing system.

Another object of the present invention is to a new and improved host computing system, having one or more CPUs and employing a parallel graphics processing system having object-division mode of parallel graphics processing, wherein each frame of a 3D scene to be rendered is divided into a set of minimal tasks (where each task is considered as a macro-object of sorts), and then, in the spirit of object-division parallelism, the processing of these divided tasks are distributed between multiple GPU's in a real-time manner during the run-time of the graphics-based application executing on the CPU(s) of the host computing system.

These and other objects of the present invention will become apparent hereinafter and in the claims to invention.

### BRIEF DESCRIPTION OF DRAWINGS OF PRESENT INVENTION

For a more complete understanding of how to practice the Objects of the Present Invention, the following Detailed Description of the Illustrative Embodiments can be read in conjunction with the accompanying Drawings, briefly described below:

FIG. 1 is a graphical representation of a PC-level based multi-GPPL parallel graphics rendering platform of the type disclosed in Applicants' copending U.S. patent application Ser. No. 11/897,536, showing multi-CPUs, system memory, a system interface, and a plurality of GPPLs, with a display interface driving one or more graphics display screens;

FIG. 2A is a schematic representation of a plurality of advanced GPU-based graphics processing pipelines (GPPLs), such as in nVidia's GeForce 8800 GTX graphics subsystem, that can be employed in the multi-GPPL graphics rendering platform of FIG. 1;

FIG. 2B is a schematic representation of a plurality of multicore-based graphics processing pipelines (GPPLs), such as Intel's Larrabee graphics system, that can be employed in the multi-GPPL graphics rendering platform of FIG. 1;

FIG. 3A is a schematic representation of an illustrative embodiment of the PC-based host computing system of the present invention (a) embodying an illustrative embodiment of the parallel 3D graphics processing system (PGPS) of the present invention supporting a new and improved method of task-based object division parallelism, along with other modes of parallelism (e.g. time division, frame division, and classical object division) during the run-time of a graphics based application executing on the CPU(s) of the host computing system, and (b) comprising (i) a parallel mode control module (PMCM), (ii) a parallel graphics processing subsystem for supporting the parallelization stages of decomposition, distribution and re-composition implemented using a decomposition module, a distribution module and a re-composition module, respectively, and (ii) a plurality of either GPU and/or CPU based graphics processing pipelines (GPPLs) operated in a parallel manner under the control of the PMCM;

FIG. 3B1 is a schematic representation of the subcomponents of a first illustrative embodiment of a GPU-based graphics processing pipeline (GPPL) that can be employed in the PGPS of the present invention depicted in FIG. 3A, shown comprising (i) a video memory structure supporting a frame buffer (FB) including stencil, depth and color buffers, and (ii) a graphics processing unit (GPU) supporting (1) a geometry subsystem having an input assembler and a vertex shader, (2) a set up engine, and (3) a pixel subsystem including a pixel shader receiving pixel data from the frame buffer and a raster operators operating on pixel data in the frame buffers;

FIG. 3B2 is a schematic representation of the subcomponents of a second illustrative embodiment of a GPU-based graphics processing pipeline (GPPL) that can be employed in the POPS of the present invention depicted in FIG. 3A, shown comprising (i) a video memory structure supporting a frame buffer (FB) including stencil, depth and color buffers, and (ii) a graphics processing unit (GPU) supporting (1) a geometry subsystem having an input assembler, a vertex shader and a geometry shader, (2) a rasterizer, and (3) a pixel subsystem including a pixel shader receiving pixel data from the frame buffer and a raster operators operating on pixel data in the frame buffers;

FIG. 3B3 is a schematic representation of the subcomponents of an illustrative embodiment of a CPU-based graphics processing pipeline that can be employed in the PGPS of the present invention depicted in FIG. 3A, and shown comprising (i) a video memory structure supporting a frame buffer including stencil, depth and color buffers, and (ii) a graphics processing pipeline realized by one cell of a multi-core CPU chip, consisting of 16 in-order SIMD processors, and further including a GPU-specific extension, namely, a texture sampler that loads texture maps from memory, filters them for level-of-detail, and feeds to pixel processing portion of the pipeline;

FIG. 3C is a schematic representation illustrating the pipelined structure of the parallel graphics processing system (PGPS) of the present invention shown driving a plurality of GPPLs, wherein the decomposition module supports the scanning of commands, the control of commands, the tracking of objects (including “tasks” subdivided on a frame-by-frame basis), the balancing of loads, and the assignment of objects to GPPLs, wherein the distribution module supports transmission of graphics data (e.g. FB data, commands, textures, geometric data and other data) in various modes including CPU-to/from-GPU, inter-GPPL, broadcast, hub-to/from-CPU, and hub-to/from-CPU and hub-to/from-GPPL, and wherein the re-composition module supports the merging of partial image fragments in the Color Buffers of the GPPLs in a variety of ways, in accordance with the principles of the present invention (e.g. merge color frame buffers without z buffers, merge color buffers using stencil assisted processing, and other modes of partial image merging);

FIG. 4A is a graph-type schematic representation illustrating three graphics tasks associated with a graphics application running on the host computing system of the present invention, depicted in FIGS. 3A through 3C, with the dependency among these task-based objects being schematically illustrated;

FIG. 4B is a schematic representation illustrating the flow of graphics task-based objects of FIG. 4A, occurring within a single GPPL of the parallel graphics processing system (PGPS) of the present invention;

FIG. 4C is a schematic representation illustrating the division of graphics task-based objects between two GPPLs of the parallel graphics processing system (PGPS) of the present invention, including the copying of intermediate results from one GPPL to another GPPL, according to the principles of the present invention;

FIG. 5A is a graphical representation of an exemplary scene (in a graphics-based application running on the host computing system of FIG. 3A) which has two light sources (e.g. moonlight, and a flashlight), and three objects, and is to be rendered by the parallel graphics processing subsystem of the present invention operating in its the task-based object division mode of parallelism in accordance with the principles of the present invention;

FIG. 5B is a graphical representation illustrating the graphics code associated with the exemplary scene of FIG. 5A, shown divided to blocks according to the method of task-based object division according to the principles of the present invention;

FIG. 5C is a graphical representation of a block dependency graph constructed for the scene of FIG. 5A, in accordance with the principles of the present invention, and showing the dependency among particular nodes associated with particular tasks to be performed during the rendering of the scene;

FIG. 5D is a graphical representation illustrating the flow of rendering operations for the scene of FIG. 5A, wherein nodes in the block dependency graph are selected for rendering in an order which satisfies the dependencies, and that the Block entitled ‘Main Render’ consists of a single (graphics processing) task;

FIG. 5E is a graphical representation illustrating the parallel rendering of the scene of FIG. 5A, wherein the Block entitled ‘Main Render’ is divided into several newly-created task-based objects while the parallel graphics processing subsystem of the present invention is operated in its task-based image division mode of parallel operation;

FIG. 5F is a graphical representation illustrating the parallel rendering of the scene of FIG. 5A, wherein the Block entitled ‘Main Render’ is divided into several newly-created task-objects while the parallel graphics processing subsystem of the present invention is operated in its task-based image division mode of parallel operation;

FIG. 6 is a block diagram type graphical representation illustrating the primary steps of the method of parallel graphics processing carried out by the parallel graphics processing subsystem operating in its “task-based” object division mode of parallelism according to the principles of the present invention;

FIG. 7A is a graphical representation illustrating an exemplary image that is generated using a simple task-based object consisting of a ‘Clear’ command and 3 Draw calls;

FIG. 7B a graphical representation illustrating the handling and processing of the unparalleled task-based object of FIG. 7A, running on a single GPPL of a parallel graphics processing subsystem in a hosting computing system;

FIG. 7C a graphical representation illustrating the handling and processing of the task-based object of FIG. 7A, when processed according to the image division method of the parallel graphics processing, supported by a dual-GPPL parallel graphics processing subsystem according to the present invention; and

FIG. 7D a graphical representation illustrating the handling and processing of the task-based object of FIG. 7A, when processed according to the task-based object division method of the parallel graphics processing, supported by a dual-GPPL parallel graphics processing subsystem according to the present invention.

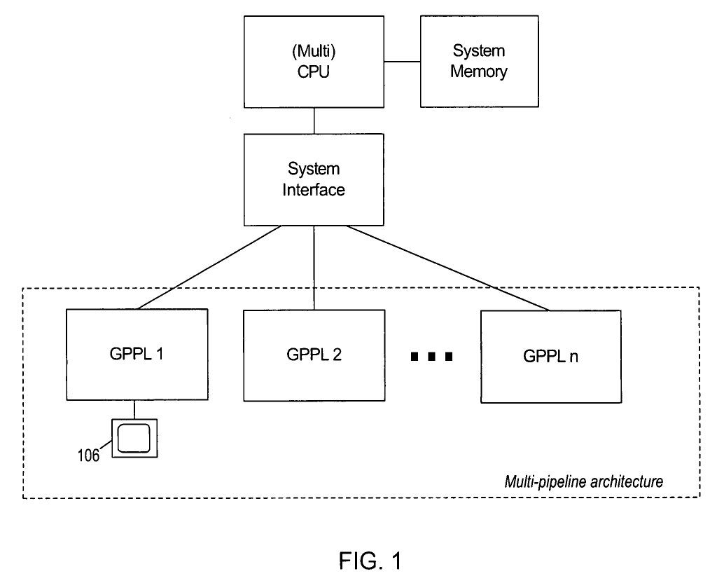

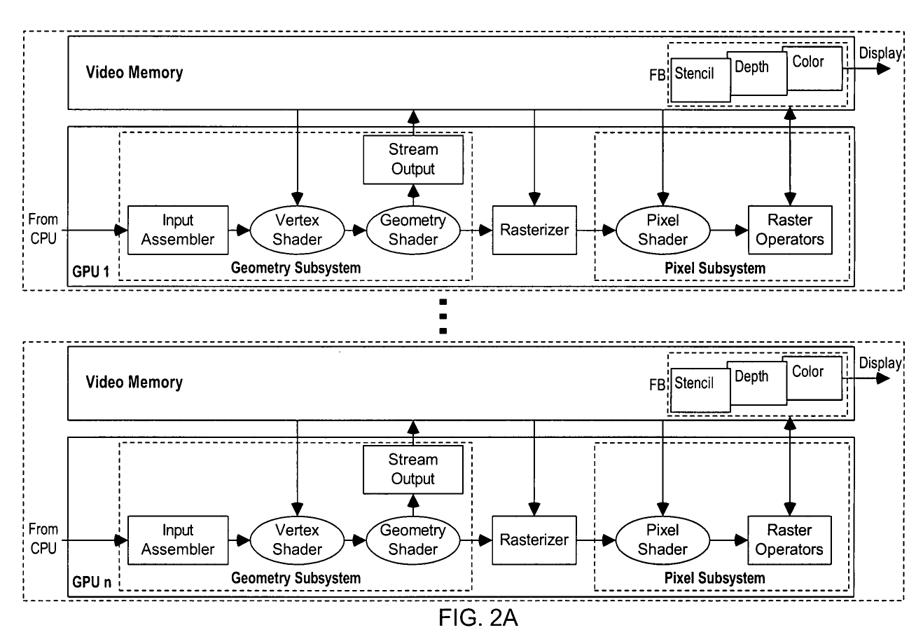

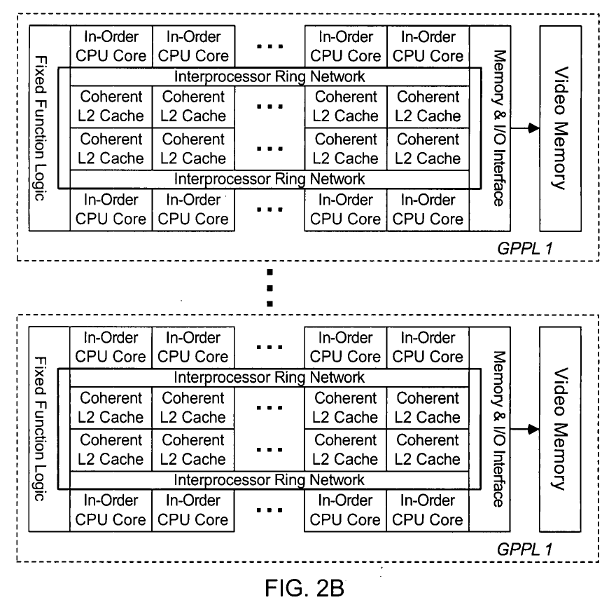

### DETAILED DESCRIPTION OF THE ILLUSTRATIVE EMBODIMENTS OF THE PRESENT INVENTION

In contemporary graphics applications, multiple rendering targets are used, rather than a single back-buffer. Scene objects are simultaneously rendered to a set of rendering ‘surfaces’ in texture memory in order to generate effects such as shadow maps and reflections. The rendering ‘surfaces’ can be rendered in various orders, however any order must satisfy the dependencies between surfaces. In some stage all ‘surfaces’ must be merged into back buffer.

The present invention monitors the rendering order and controls the rendering flow by breaking down the sequence of rendering commands into blocks. Some of the heaviest blocks are farther break down into entities called task-objects. There are different possible break down (graphics frame/stream division) schemes according to the chosen parallelization mode of parallelism: e.g. time-division, image division, classical (depth-based) object division, or ‘depthless’ object division, each being supported in real-time in Applicants' parallel graphics processing system described great detail in copending U.S. application Ser. No. 12/077,072, incorporated herein by reference. Optimization of the scheme and tasks-objects parallelization among multiple GPPLs is carried out by a scheduler.

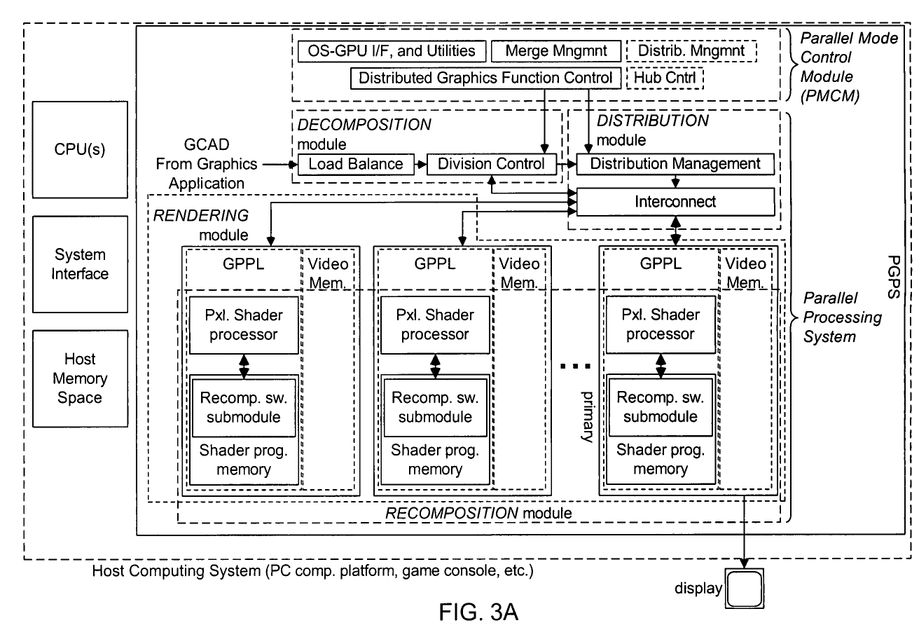

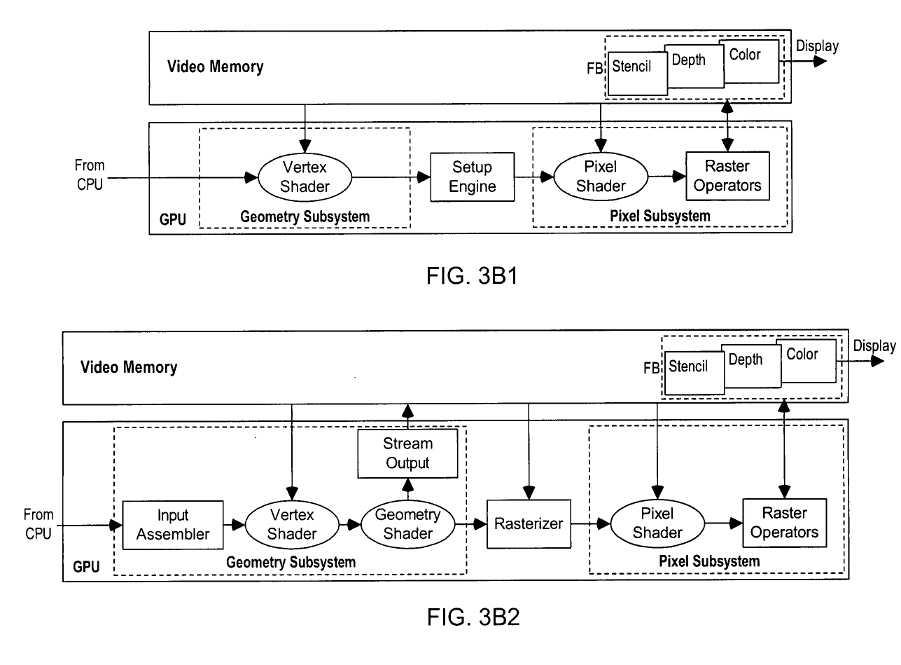

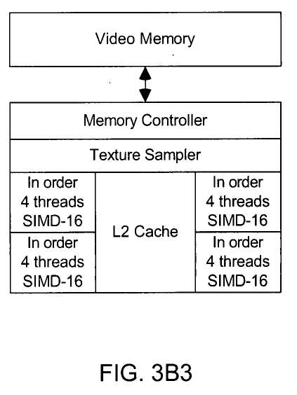

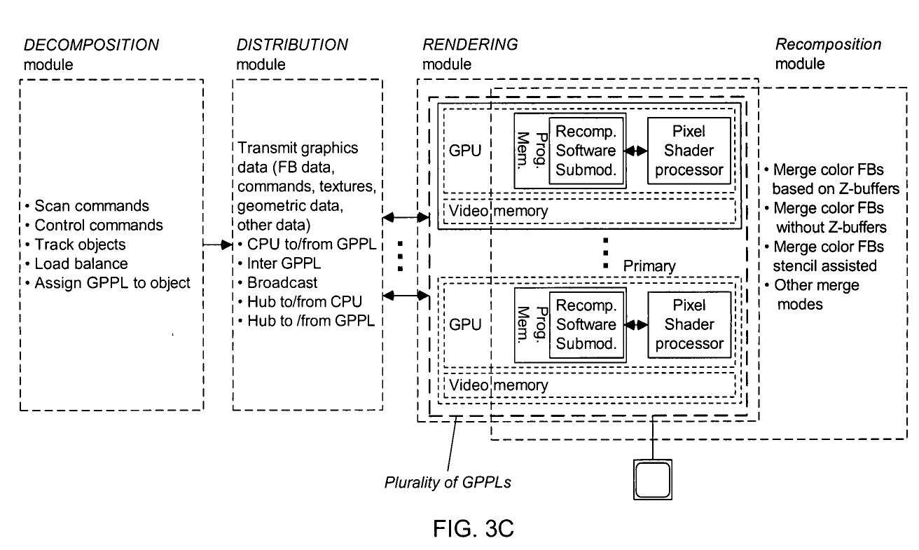

FIGS. 3A through 3C show an illustrative embodiment of the PC-based hosting processing system of the present invention embodying a new and improved parallel graphics processing subsystem which supports a task-based object division mode of parallelism according to the principles of the present invention, in addition to a time-division mode, a classical depth-based object division modem, and a depth-less object division mode of parallelism, described in great detail in copending application Ser. No. 12/077,072, supra.

The parallel 3D graphics processing system and method of the present invention can be practiced in diverse kinds of computing and micro-computing environments in which 3D graphics support is required or desired. Referring to FIGS. 3A through 3C, the parallel graphics processing system (PGPS) of the present invention will now be described in greater detail.

In FIG. 3A, there is shown a PC-based host computing system embodying an illustrative embodiment of the parallel 3D graphics processing system (PGPS) platform of the present invention. As shown, the PGPS comprises: (i) a Parallel Mode Control Module (PMCM); (ii) a Parallel Processing Subsystem for supporting the parallelization stages of decomposition, distribution and re-composition implemented using a Decomposition Module, a Distribution Module and a Re-Composition Module, respectively; and (ii) a plurality of either GPU and/or CPU based graphics processing pipelines (GPPLs) operated in a parallel manner under the control of the PMCM.

As shown, the PMCM further comprises an OS-GPU interface (I/F) and Utilities; Merge Management Module; Distribution Management Module; Distributed Graphics Function Control; and Hub Control, as described in greater detail in U.S. application Ser. No. 11/897,536 filed Aug. 30, 2007, incorporated herein by reference.

As shown, the Decomposition Module further comprises a Load Balance Submodule, and a Division Submodule, whereas the Distribution Module comprises a Distribution Management Submodule and an Interconnect Network.

Also, the Rendering Module comprises the plurality of GPPLs, whereas the Re-Composition Module comprises the Pixel Shader, the Shader Program Memory and the Video Memory (e.g. Z Buffer and Color Buffers) within each of the GPPLs cooperating over the Interconnect Network.

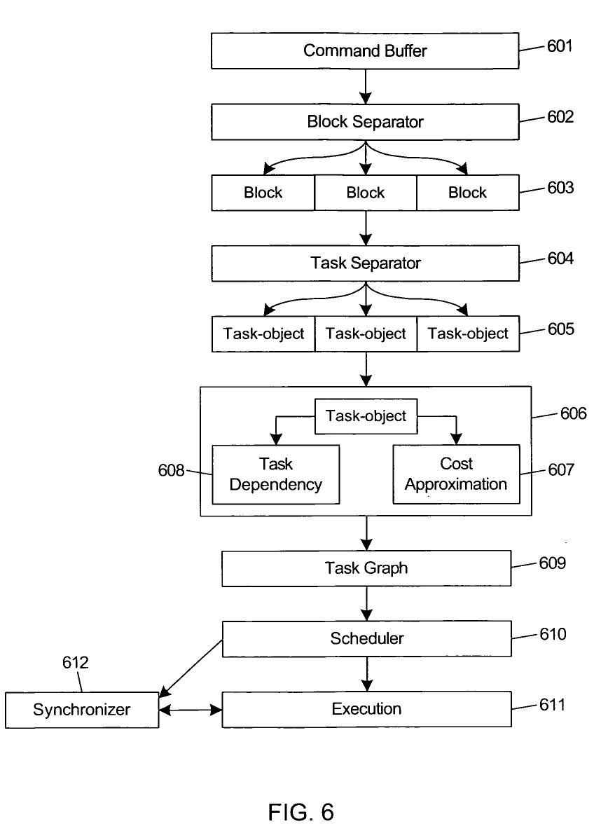

In FIG. 3B1, a first illustrative embodiment of a GPU-based graphics processing pipeline (GPPL) is shown for use in the PGPS of the present invention depicted in FIG. 6A. As shown, the GPPL comprises: (i) a video memory structure supporting a frame buffer (FB) including stencil, depth and color buffers, and (ii) a graphics processing unit (GPU) supporting (1) a geometry subsystem having an input assembler and a vertex shader, (2) a set up engine, and (3) a pixel subsystem including a pixel shader receiving pixel data from the frame buffer and a raster operators operating on pixel data in the frame buffers.

In FIG. 3B2, a second illustrative embodiment of a GPU-based graphics processing pipeline (GPPL) is shown for use in the PGPS of the present invention depicted in FIG. 3A. As shown, the GPPL comprises (i) a video memory structure supporting a frame buffer (FB) including stencil, depth and color buffers, and (ii) a graphics processing unit (GPU) supporting (1) a geometry subsystem having an input assembler, a vertex shader and a geometry shader, (2) a rasterizer, and (3) a pixel subsystem including a pixel shader receiving pixel data from the frame buffer and a raster operators operating on pixel data in the frame buffers.

In FIG. 3B3, an illustrative embodiment of a CPU-based graphics processing pipeline (GPPL) is shown for use in the PGPS of the present invention depicted in FIG. 3A. As shown, the GPPL comprises (i) a video memory structure supporting a frame buffer including stencil, depth and color buffers, and (ii) a graphics processing pipeline realized by one cell of a multi-core CPU chip, consisting of 16 in-order SIMD processors, and further including a GPU-specific extension, namely, a texture sampler that loads texture maps from memory, filters them for level-of-detail, and feeds to pixel processing portion of the pipeline.

In FIG. 3C, the pipelined structure of the parallel graphics processing system (PGPS) of the present invention is shown driving a plurality of GPPLs. As shown, the Decomposition Module supports the scanning of commands, the control of commands, the tracking of objects, the balancing of loads, and the assignment of objects to GPPLs. The Distribution Module supports transmission of graphics data (e.g. FB data, commands, textures, geometric data and other data) in various modes including CPU-to/from-GPU, inter-GPPL, broadcast, hub-to/from-CPU, and hub-to/from-CPU and hub-to/from-GPPL. The Re-composition Module supports the merging of partial image fragments in the Color Buffers of the GPPLs in a variety of ways, in accordance with the principles of the present invention (e.g. merge color frame buffers without z buffers, merge color buffers using stencil assisted processing, and other modes of partial image merging).

Having described the system architecture of the illustrative embodiment of the present invention, it is now appropriate to focus attention to its new and improved mode of parallel graphics processing carried out according to its tasked-based object division principles of operation.

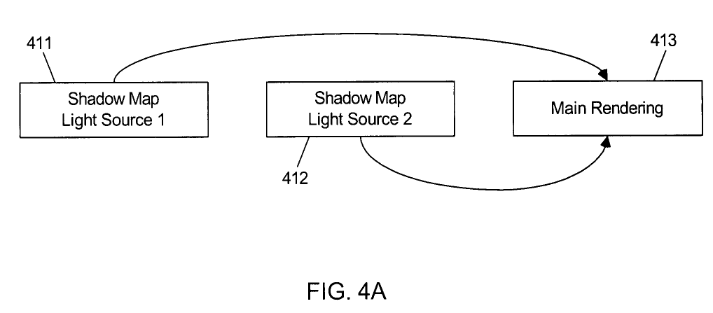

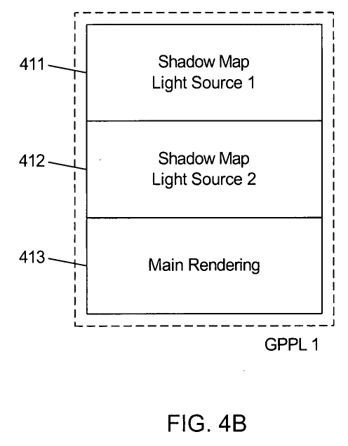

When a task-object uses or creates a render target that is used by subsequent rendering operation to a different target, a dependency is set up between the two task objects. A simplified example is shown in FIG. 4A, in which a frame consists of three task-objects: task-object 411 generates shadow map of first light source, 412 generates shadow map of second source, and 413 is the main rendering task-object of a scene into the back buffer and depth/stencil buffer. Task-object 413 has a dependency on the task objects for each of the shadow maps. FIG. 4B shows rendering in a single GPPL, keeping the order 411, 412, 413. However the nodes can be processed in any order that satisfies the dependencies, i.e. 412, 411, 413 as well. The same frame is shown in FIG. 4C rendered in two separate GPPLs. The task-object 413 in GPPL1 cannot be rendered until the result texture of task-object 412 is copied (431) from GPPL2 to GPPL1.

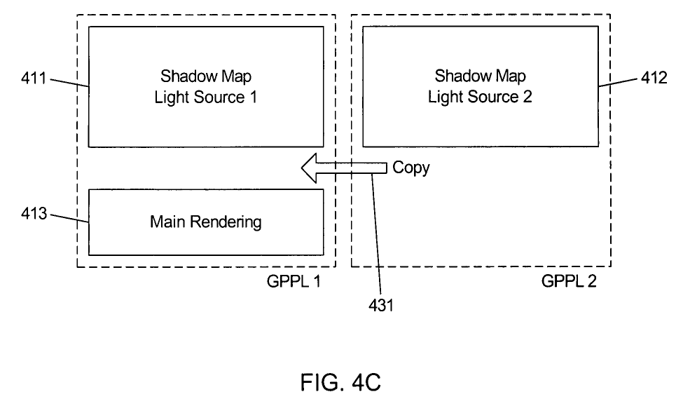

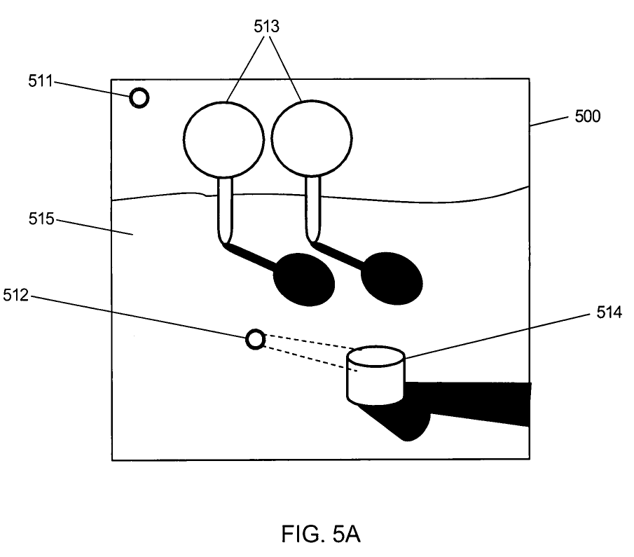

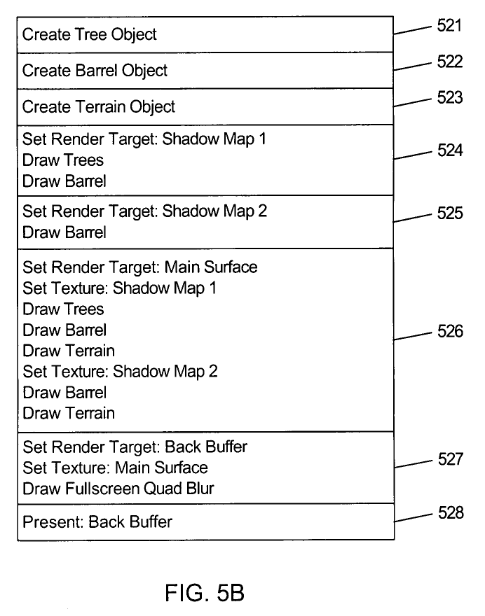

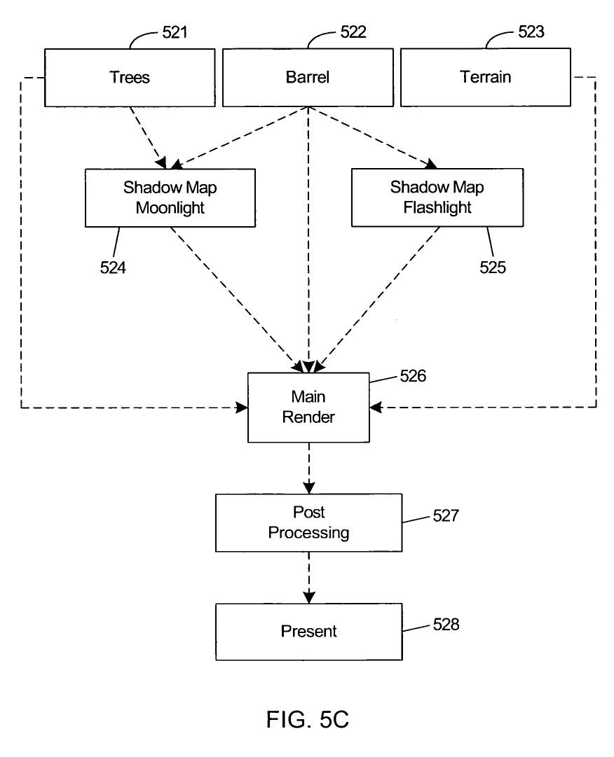

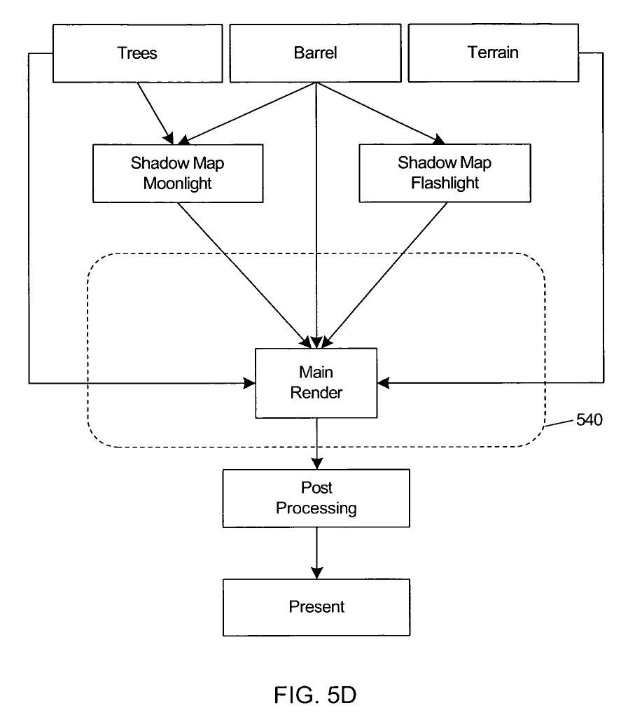

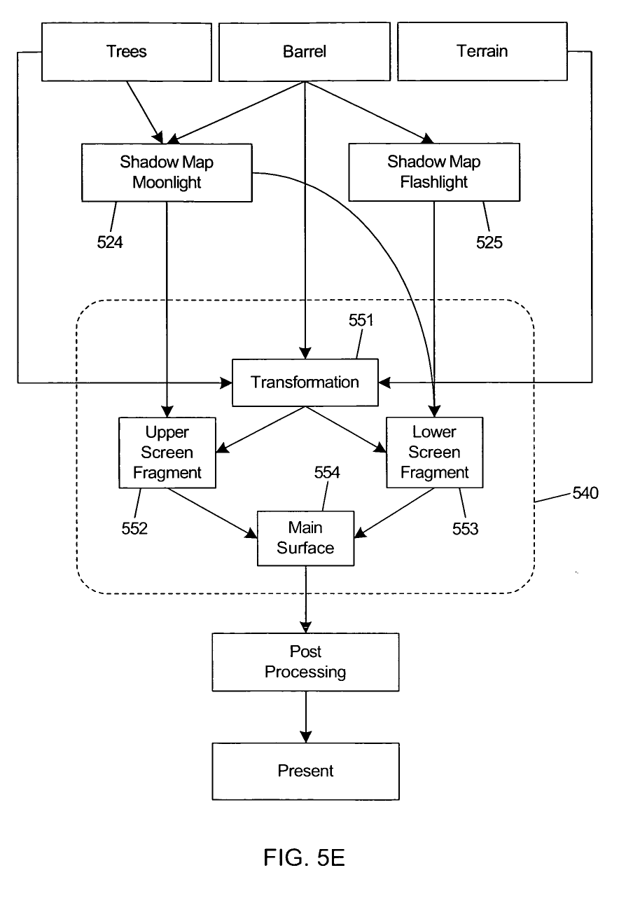

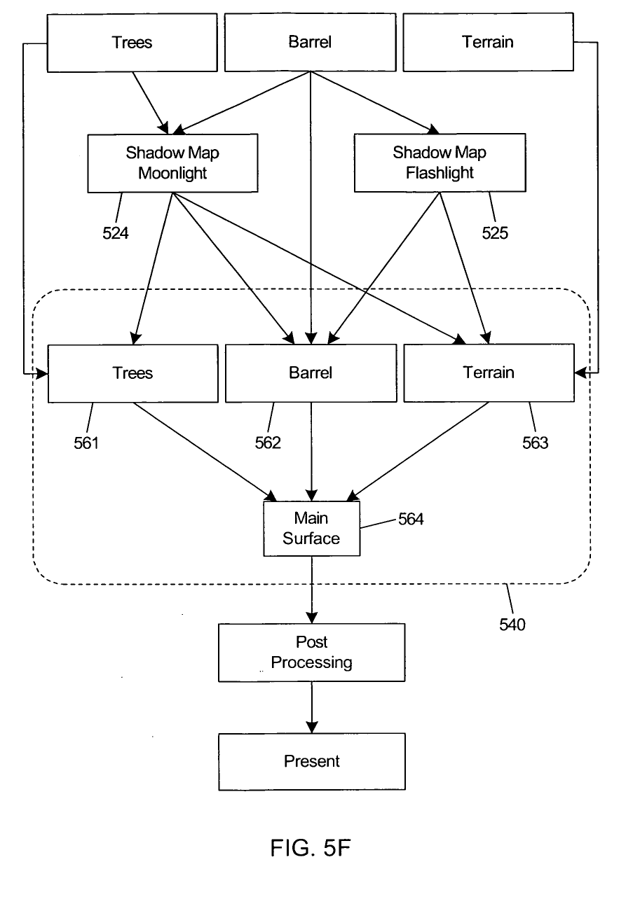

FIG. 5A shows an exemplary scene on which the task-object method will be explained in detail. It consists of three objects (trees 513, barrel 514 and terrain 515), and two light sources (the moon 511, and flashlight 512). There are two notably points in this scene (i) the trees and the barrel are the only objects casting shadows of the moon light, and (ii) the trees are placed in the upper half of the image, while the barrel falls in the lower half.

This scene is generated by the code of FIG. 5B. It is divided into blocks of commands. 521-523 create the objects of Tree, Barrel and Terrain, respectively. Blocks 524 and 525 generate shadow maps of moon light and flashlight into two separate textures, ‘Shadow Map 1’ and ‘Shadow Map 2’. In the first one two objects are processed for shadowing, Trees and Barrel, in the second the Barrel only. The next command set of block 526 makes the main rendering onto the ‘Main Surface’ texture: first shadow map is transformed into scene of Trees, Barrel and Terrain, then second shadow map is transformed into scene of Barrel and Terrain. Each one transformed on its relevant objects. During the next block 527 the main surface is moved to Back Buffer, and the image is being blurred by drawing a quad in the size of a full screen. This block is usually called ‘post processing’ since the final image can be processed for Depth of Field, Motion blur, High Dynamic Range, Hud (e.g. score figures of video games), etc. In block 528 the image is presented to display.

The above code is converted into Block Dependency Graph of FIG. 5C, having 8 nodes, corresponding to the eight blocks of FIG. 5B. The node ‘Shadow Map Moonlight’ 524 depends on Trees and Barrel. The node ‘Shadow Map Flashlight’ depends on Barrel only. ‘Main Render’ node 526 depends on all objects and all shadow maps. Then there is single dependency of ‘Post Processing’ 527 on 526, and 528 on 527.

In FIG. 5D the rendering flow is shown. Nodes are selected for rendering in an order that satisfies the dependencies. Typically, the ‘Main Render’ surface, as the most populated node is subject to parallelization; however at this flow graph the ‘Main Render’ block 540 still consists of a single task, no parallelization.

FIG. 5E shows Image Division parallelization. The block 540 breaks down into four tasks-objects. 551 is vertex processing task-object performing 3D transformation on all three objects of the scene. 552 and 553 are fragment processing tasks-objects, each task handles one half of the screen. Task-object 552 drains the transformed and rasterized polygons from 551, and the shadowmap texture from 524. Task-object 552 intakes the transformed and rasterized polygons from 551, and the shadowmap texture of 525. The last task-object in the block is the ‘Main Surface’ 554 that merges the images of 552 and 553. This task-object structure of 540 allows processing in parallel. For example, for 2 GPUs, 554 will be broadcast to both, 552 and 553 will be divided between GPUs, and 554 will be merged into one of them. As it will become clear, the decision on parallelism, the break down to task-objects and division of tasks-objects is done by the Scheduler.

FIG. 5F shows Object Division parallelization. This time the block 540 breaks down into four different task-objects, as the entire scene is decomposed to three subscenes; 561-563 for Trees, Barrel and Terrain, respectively. Each of these Task-objects perform complete rendering pipeline from vertices to pixels. The partial results are recomposed in 564. It is notable that it can be either classic or depthless object division.

The host computing system of the present invention performing task-object based graphics parallelization of present invention is depicted in FIG. 6.

Task-object and sub frame division, refers to the ability to divide a frame to minimal tasks, and distribute the processing of these tasks between multiple GPU's. This is a new way of graphics parallelization in a sub-frame resolution. In order to break down the entire flow of the rendering to task-objects within a single frame, the stream of commands must be scanned and a map of all the textures and surfaces that are used during the scene must be created. The tasks are then organized in a Task Graph, which is sent to a Scheduling mechanism. At last, the tasks are executed on the desired GPU(s), the partial results are inter-communicated by the synchronizer mechanism, and the next tasks are being processed.

Every command sent by the application to the 3D Engine, is intercepted and accumulated in a Command Buffer 601.

The Block Separator 602 processes the Command Buffer. Each set of commands could be defined as a Block 603. For example, a block could be created for each draw command and its preceding commands, or for all commands between two SetRenderTarget commands, or even an entire frame. The definitions of block could vary due to some reasons: Larger blocks (and therefore fewer blocks) are faster to analyze, thus saving CPU time. Smaller blocks allow more precise distribution.

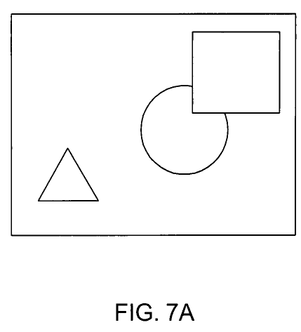

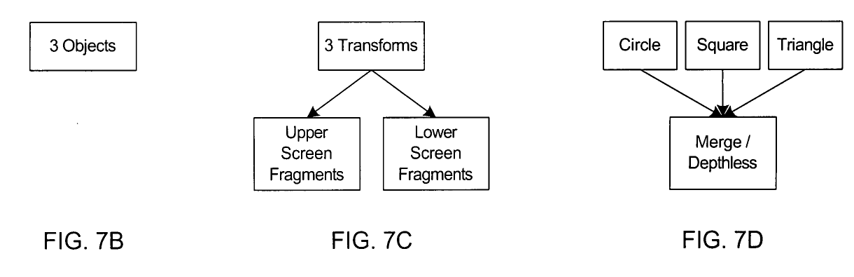

Each Block can be break down to task-objects in several ways, according to the various parallelization modes (such as Image Division, Object Division, and Depthless Object Division). The Task Separator 604 is responsible of splitting the block to a set of optional Processing Techniques, each technique, consisting of several Tasks-objects. For example, assume we have a simple Block with a Clear command and 3 Draw calls, generating image of FIG. 7A.

This block could generate several Task-object sets, as shown in FIGS. 7B to 7D. For each generated task-object set, the Task Handler 606 evaluates the Task Dependency 608 and the Task Cost Approximation 607.

The Dependency 608 component finds all the resources updated and needed by this block task. For example, a drawing block, updates the Render Target, and probably the Z-Buffer too, and it depends on the Vertex Buffer, the sampled Textures, and again the Z-Buffer.

The Cost Approximation 607 module is responsible of approximating the cost of a task, before it is being executed. Typically the cost depends on the amount of work to be done, and the cost of communication to/from the task-object, depending mostly on the size of the resource (in Bytes), and the bandwidth of the PCI-e Bus. The approximation of cost is critical for scheduling, and therefore must occur before the execution and should be as precise as possible. The module attempts to find a correlation between the streamed commands, and the true cost of a task.

What is claimed is:

1. A host computing system comprising:
a system memory for storing one or more graphics applications for generating frames within scenes having 3D objects;
one or more CPUs for executing said one or more graphics based applications and generating streams of graphics commands and data representative of frames within scenes generated by said graphics applications;
a plurality of graphics processing pipelines (GPPLs) for processing said graphics commands and data and rendering images consisting of pixels;
a system interface interfacing said CPUs, said system memory and said GPPLs;
a display interface for driving one or more graphics display screens and displaying said rendered images; and
a parallel graphics processing subsystem (PGPS), employing said GPPLs, and supporting a task-based object division mode of parallelism, along with at least one addition mode of parallelism selected from the group consisting of time division, frame division, and classical object division, during the run-time of a graphics based application executing on said CPU(s).

2. The hosting computing system of claim 1, which further comprises a parallel mode control module (PMCM), and wherein said parallel graphics processing subsystem supports the parallelization stages of decomposition, distribution and re-composition implemented using a decomposition module, a distribution module and a re-composition module, respectively, and (ii) a plurality of either GPU and/or CPU based graphics processing pipelines (GPPLs) operated in a parallel manner under the control of said PMCM.

3. The hosting computing system of claim 1, wherein at least one of said GPPLs comprises a GPU-based graphics processing pipeline (GPPL).

4. The hosting computing system of claim 1, wherein at least one of said GPPLs comprises a CPU-based graphics processing pipeline.

5. The hosting computing system of claim 1, wherein during said task-based object division mode, graphics task-based objects are divided between at least GPPLs of said parallel graphics processing system, including the copying of intermediate results from one said GPPL to another said GPPL.

6. The hosting computing system of claim 1, wherein a scene within said graphics application is decomposed into blocks of code, including a main render which consists of a single (graphics processing) task, and wherein said main render is divided into several newly-created task-based objects while said parallel graphics processing subsystem is operated in said task-based image division mode of parallel operation.

7. A parallel graphics processing subsystem (PGPS) for embodying in a host computing system including (i) system memory for storing one or more graphics applications for generating frames within scenes having 3D objects, (ii) one or more CPUs for executing said one or more graphics based applications and generating streams of graphics commands and data representative of frames within scenes generated by said graphics applications, (iii) a system interface interfacing said CPUs and said system memory and a plurality of graphics processing pipelines (GPPLs), and (iv) a display interface for driving one or more graphics display screens and displaying said rendered images, said PGPS comprising:
said plurality of graphics processing pipelines (GPPLs) for processing said graphics commands and data and rendering images consisting of pixels, and supporting a task-based object division mode of parallelism, along with at least one addition mode of parallelism selected from the group consisting of time division, frame division, and classical object division, during the run-time of a graphics based application executing on said CPU(s); and
a parallel mode control module (PMCM) for controlling the mode of parallel operation of said GPPLs.

8. The parallel graphics processing subsystem of claim 7, which further supports the parallelization stages of decomposition, distribution and re-composition implemented using a decomposition module, a distribution module and a re-composition module, respectively.

9. The parallel graphics processing subsystem of claim 7, wherein at least one of said GPPLs comprises a GPU-based graphics processing pipeline (GPPL).

10. The parallel graphics processing subsystem of claim 7, wherein at least one of said GPPLs comprises a CPU-based graphics processing pipeline (GPPL).

11. The parallel graphics processing subsystem of claim 7, wherein during said task-based object division mode, graphics task-based objects are divided between at least GPPLs of said parallel graphics processing system, including the copying of intermediate results from one said GPPL to another said GPPL.

12. The parallel graphics processing subsystem of claim 7, wherein a scene within said graphics application is decomposed into blocks of code, including a main render which consists of a single (graphics processing) task, and wherein said main render is divided into several newly-created task-based objects while said parallel graphics processing subsystem is operated in said task-based image division mode of parallel operation.

13. A method of operating a plurality of parallel graphics processing pipelines (GPPLs) supported on a parallel graphics processing subsystem (PGPS) embodied within a host computing system including (i) system memory for storing one or more graphics applications for generating frames within scenes having 3D objects, (ii) one or more CPUs for executing said one or more graphics based applications and generating streams of graphics commands and data representative of frames within scenes generated by said graphics applications, (iii) a system interface interfacing said CPUs and said system memory and a plurality of graphics processing pipelines (GPPLs), and (iv) a display interface for driving one or more graphics display screens and displaying said rendered images, said method comprising the steps of:
(a) operating said PGPS in a task-based object division mode of operation during the run-time of a graphics based application executing on said CPU(s);
(b) within each frame in said scene to be rendered, analyzing said stream of graphics commands and data for graphics processing tasks associated said frame;
(c) distributing said graphics processing tasks among plurality of GPPLs; and
(d) each said GPPL executing graphics processing tasks distributed to the GPPL during step (c), and processing said graphics commands and data associated with said distributed graphics processing tasks, and rendering partial image components, and
(e) recompositing said partial image components to produce a complete image for said frame and displaying said complete image on said one or more display screens.

14. The method of claim 13, wherein step (c) comprises rendering partial image components using a depth-less based method of image rendering.
